(19) United States
(12) Patent Application Publication
(10) Pub. No.: US 2025/0040611 A1
(43) Pub. Date: Feb. 6, 2025

(54) MULTI-PURPOSE CONTAINER CLOSURE WITH HEATING ELEMENT AND BATTERY

(71) Applicant: Jason Ashton, Watsonville, CA (US)

(72) Inventor: Jason Ashton, Watsonville, CA (US)

(21) Appl. No.: 18/787,359

(22) Filed: Jul. 29, 2024

Related U.S. Application Data
(60) Provisional application No. 63/516,820, filed on Jul. 31, 2023.

(51) Int. Cl. A24F 40/485; A24F 40/10; A24F 40/42; A24F 40/46; A24F 40/51; A47G 19/22; B65D 47/30; H05B 3/42

(52) U.S. Cl. CPC A24F 40/485; A24F 40/10; A24F 40/42; A24F 40/46; A24F 40/51; A47G 19/2272; B65D 47/30; H05B 3/42

(57) ABSTRACT

A closure for a beverage container has a body adapted to engage to a top of the beverage container, an enclosure sealed to an underside of the body, a first access element providing a first passage into the separate enclosure, a heating element with a pressure sensor and a threaded interface opening into the separate enclosure, a rechargeable battery in the body connected to the heating element, a vape cartridge engaged in the threaded interface of the heating element, and a second access element providing a second passage to a tubing extending downward from an underside of the body of the closure. A user is enabled to draw liquid from the vape cartridge by the first access element, the pressure sensor triggering the heating element to vaporize the liquid, which the user draws through the first passage.

### CROSS-REFERENCE TO RELATED APPLICATIONS

The present application claims priority to provisional patent application 63/516,820, filed Jul. 31, 2023. All disclosure of the parent application is incorporated at least by reference.

### BACKGROUND OF THE INVENTION

### 1. Field of the Invention

The present invention is in the technical area of apparatus and methods for vaping and/or smoking materials and pertains more particularly to a container closure that comprises at least one heating element and a battery, both enclosed in a body of the container closure.

### 2. Description of Related Art

There exist in the conventional art a considerable variety of beverage containers, such as water and coffee containers adapted for users to fill and refill, and to ingest beverage from the container as desired. There exist in the art as well a considerable variety of apparatuses for consuming liquid materials, organic material, and other liquids in some cases in the form of vapor pens and disposable vapor pen cartridges and the like for users to consume the vaporized material and the like as desired. What is needed is a closure for existing beverage containers, the closure having apparatus with alternative draw elements that allows drawing liquid, such as coffee or water from the container by one draw element and allows drawing vapor using a separate draw element, the vapor produced from material in a cartridge that is vaporized in a heating element in a body of the closure, the heating element powered by a battery in the enclosure.

### BRIEF SUMMARY OF THE INVENTION

In an embodiment of the invention a closure for a beverage container is provided, comprising a body having an attachment interface adapted to engage to a top of the beverage container, a separate enclosure sealed to an underside of the body of the closure, a first access element providing a first passage from above the body of the closure through and into the separate enclosure, a heating element having a through passage engaged in the first passage with a threaded interface opening into the separate enclosure, the heating element having a pressure sensor, a rechargeable battery encased in the body of the closure, the battery connected to the heating element. a vape cartridge with a threaded end engaged in the threaded interface of the heating element, the vape cartridge suspended within the separate enclosure, and a second access element providing a second passage from above the body of the closure to a tubing extending downward from an underside of the body of the closure. A user is enabled to draw liquid from the vape cartridge by the first access element, the pressure sensor triggering the heating element to vaporize the liquid, which the user draws through the first passage.

In one embodiment the beverage container holds a beverage outside the separate, sealed enclosure, the tubing from the second passage extends into the beverage, and the user is enabled to draw beverage by the second access element through the tubing and the second passage. Also, in one embodiment the first access element is a pivoted element in a first access well, manually operable to rotate into the first access well closing the first passage, and to rotate to a raised position opening the first passage to the heating element and enabling the user to draw vapor. In one embodiment the second access element is a pivoted element in a second access well, manually operable to rotate into the second access well closing the second passage, and to rotate to a raised position opening the second passage to the tubing and enabling the user to draw beverage through the tubing and the second passage. And in one embodiment the attachment interface adapted to engage to a top of the beverage container is a female thread adapted to engage a male threaded beverage container.

In one embodiment the attachment interface adapted to engage to a top of the beverage container is a male thread adapted to engage a female threaded beverage container. Also, in one embodiment the attachment interface adapted to engage to a top of the beverage container is a flexible lip adapted to snap onto a rim of a paper cup or a beverage container having a rim similar to that of a paper cup.

In another aspect of the invention a closure for a beverage container is provided, comprising a body having an attachment interface adapted to engage to a top of the beverage container, a first passage from above the body of the closure through and into a volume within the beverage container, a heating element having a through passage engaged in the first passage with a threaded interface opening upward from a top of the closure, the heating element having a pressure sensor, a rechargeable battery encased in the body of the closure, the battery connected to the heating element, a vape cartridge with a threaded end engaged in the threaded interface of the heating element, the vape cartridge having a a mouthpiece on an end opposite the threaded end, and an access element providing a second passage from above the body of the closure to a tubing extending downward from an underside of the body of the closure. A user is enabled to draw liquid from the vape cartridge by the first access element, the pressure sensor triggering the heating element to vaporize the liquid, which the user draws through the first passage, and wherein the user is enabled to draw beverage from the beverage container through the second access element and the tubing.

In one embodiment the access element is a pivoted element in an access well, manually operable to rotate into the access well closing the second passage, and to rotate to a raised position opening the second passage to the tubing enabling the user to draw beverage. Also, in one embodiment the attachment interface adapted to engage to a top of the beverage container is a female thread adapted to engage a male threaded beverage container. In one embodiment the attachment interface adapted to engage to a top of the beverage container is a male thread adapted to engage a female threaded beverage container. And in one embodiment the attachment interface adapted to engage to a top of the beverage container is a flexible lip adapted to snap onto a rim of a paper cup or a beverage container having a rim similar to that of a paper cup.

### BRIEF DESCRIPTION OF THE SEVERAL VIEWS OF THE DRAWINGS

FIG. 1 is a perspective illustration of a beverage container with a closure having two access elements in the prior art.

FIG. 2 is a perspective illustration of the closure of FIG. 1 removed from the beverage container, in the prior art.

FIG. 3 is an elevation view of an inner enclosure with a vape pen, in the prior art.

FIG. 4 is a perspective view of a closure in an embodiment of the present invention.

FIG. 5A is a section view through the closure of FIG. 4, through well 405, in an embodiment of the invention.

FIG. 5B is the section view of FIG. 5A with an access element repositioned.

FIG. 6A is a section view through the closure of FIG. 4, through well 404, in an embodiment of the invention.

FIG. 6B is the section view of FIG. 5A with an access element repositioned.

FIG. 7 illustrates a closure for a beverage container in an alternative embodiment.

FIG. 8 illustrates a closure for a paper cup beverage container.

### DESCRIPTION OF THE INVENTION

The beverage container in embodiments of the invention may be any one of a variety of conventional beverage containers known in the art, such as, for example, a coffee container like many provided by coffee enterprises, water containers and the like. In one embodiment of the invention a closure for the container comprises a body, which in one example has an internal female thread to engage a male threaded top of the beverage container. In alternative embodiment the closure may have a body with a male thread to engage a female threaded top of a container. In other embodiments the closure may have an interface to engage containers of other sorts, such as even paper cups and the like.

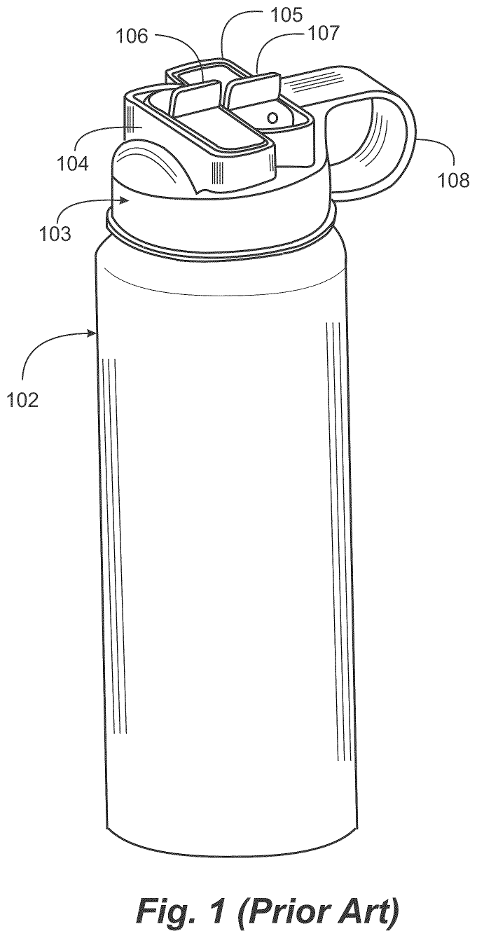

FIG. 1 is a perspective illustration of a beverage container 102 having a closure 103. This illustration is a prior art illustration from U.S. Pat. No. 10,974,881, issued Apr. 13, 2021. FIG. 1 is an elevation view of a container closure 101 engaged to a container. The container may be any one of a variety of conventional beverage containers known in the art, such as, for example, an aluminum coffee container like many provided by coffee enterprises. Closure 101 comprises a body 103, which in this prior art example has an internal female thread to engage a male threaded top of container 102. In other circumstances the closure may have a body with a male thread to engage a female threaded top of a container. In other circumstances the closure may have an interface to engage containers of other sorts, such as paper cups and the like.

In the example shown in FIG. 1 closure 101 has two access wells 104 and 105. Access well 104 has a pivoted access element 106, that when tipped up opens a path from a draw tip down through the closure into a second inner sealed enclosure within the outer enclosure of container 102. In this example a vapor-producing apparatus such as a vape pen is connected within the second sealed enclosure through access element 106, enabling a user to tip up element 106, and to draw vapor from the vapor-producing apparatus, which in this prior art example.

Access well 105 has a pivoted access element 107, similar in design and function to access element 106, that connects to a tubing under the closure, the tubing extending downward into any liquid, such as water or coffee, that may be carried in container 102. A user may tip up access element 107 and draw liquid through the tube and the access element as one would using a straw. There is a vent hole not shown that serves to equalize pressure. Finally, a handle 108 is provided on the closure to carry the closure and any added container.

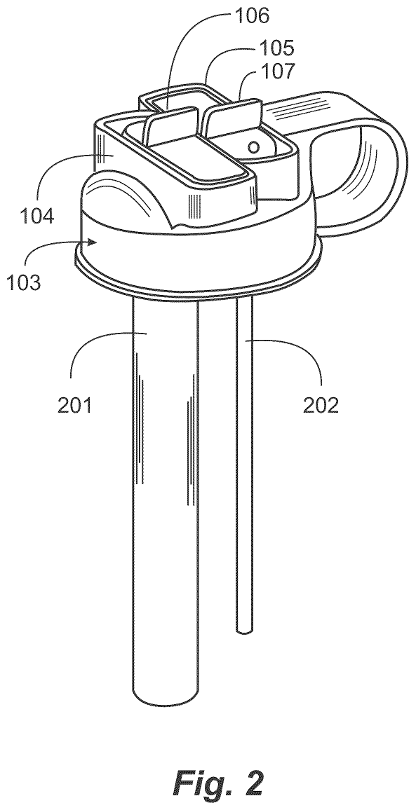

FIG. 2, also labeled prior art, illustrates closure 101 removed from container 102, showing second inner sealed enclosure 201, that may enclose, for example, a vapor-producing apparatus, such as a vape pen, and also a tubing 202 that extends downward, and may extend into any liquid that may be carried in a container like container 102. It should be noted that enclosure 201 is completely enclosed and sealed from liquid that may be in container 102, while tube 202 is open to the liquid, and extends downward into the liquid, which may be water, coffee or any other beverage. Tube 202 may be made of a suitable polymer material.

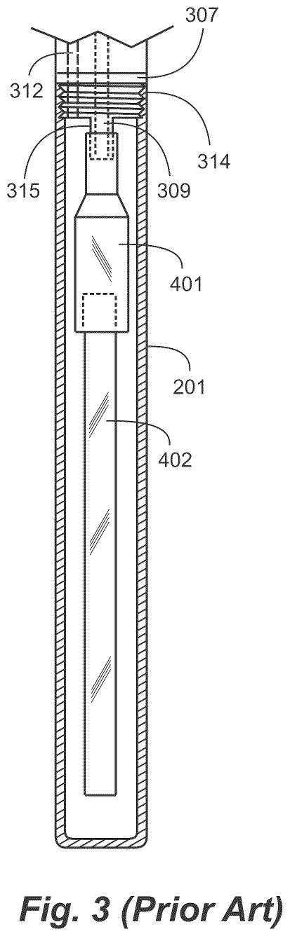

FIG. 3 is an elevation view, in section, of inner sealed enclosure 201 engaged by internal threads to threads 314 of closure 101. Sealed enclosure 201 fully engaged by threads 314 urges against a gasket 307 by which the inner volume of enclosure 201 is isolated from the volume within beverage container 102. An adapter 401, molded of a flexible polymer, has a circular opening on one end to connect to nib 315, and opening on the opposite end to connect to vape pen 402, which may be a conventional vape pen of one of several types. When access element 106 is fully rotated to a stop to align opening 304b with passage 309 a user may draw on opening 304a to ingest vapor from vape pen 402. Passage 312 provides a vent to atmosphere for the volume in enclosure 201 outside the vapor-producing apparatus.

A vape pen is a device that heats up a liquid or a material and produces vapor. A vape pen is well-known to have (1) A rechargeable battery that powers the device, (2) A sensor that activates a heating element when a user inhales or presses a button, (3) An atomizer that heats up liquid or material to a specific temperature below the combustion point, (4) A cartridge or tank that holds the liquid or material to be vaporized, and a mouthpiece that the user sucks on to inhale the vapor. In this prior art example, the vape pen is installed within the sealed enclosure 201, so the user cannot press a button on the vape pen, and activation relies on the sensor that senses the user inhaling (pressure change) to activate the heating element to produce the vapor.

In the prior art example described in detail here the user installs the vape pen in the inner sealed enclosure and installs closure 101 on the beverage container. When the ingredient, such as oil, that produces the vaper is spent, it is necessary for the user to open the beverage container, and the inner sealed enclosure, and to remove the spent vape pen and install a new vape pen, complete with battery and heating element.

It is an object of the present invention to provide a closure for a beverage container, with one or more heating elements and a rechargeable battery enclosed in a body of the closure. The heating elements have a threaded opening and are positioned in the body of the closure to provide for engaging a cartridge having vape oil or other consumable material, and a mouthpiece for the user to inhale the vapor. Such cartridges are well-known to be commercially available from a number of manufacturers. The one or more heating elements, which have the pressure sensors for initiating heating, are connected within the body of the closure to the rechargeable battery, which has a charging port on an outer surface of the body of the closure.

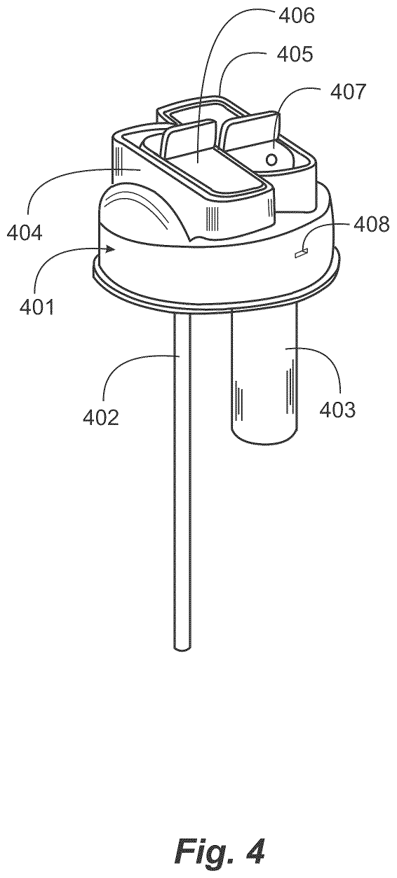

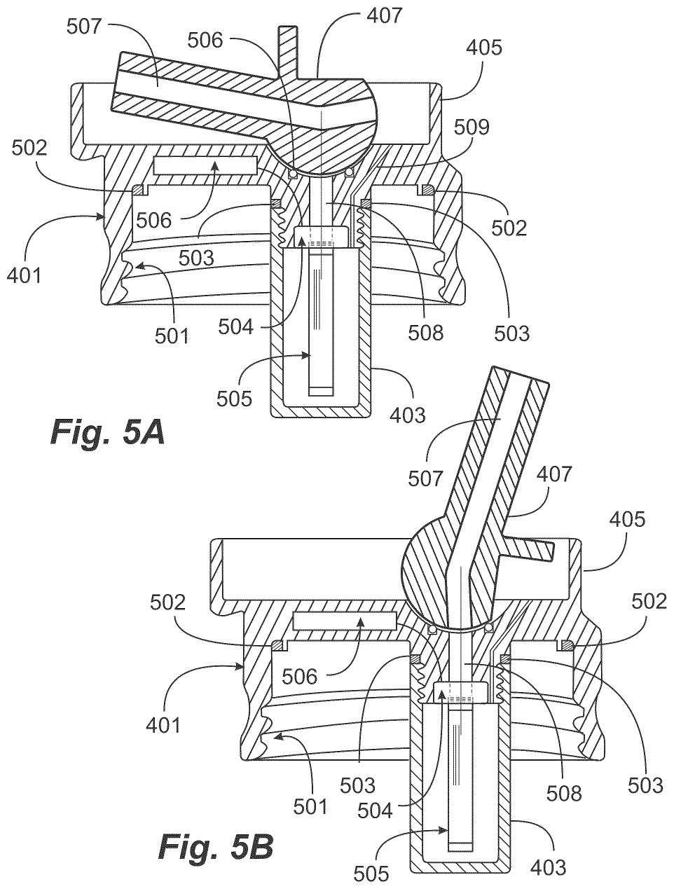

FIG. 4 is a side elevation view of a closure 401 according to an embodiment of the present invention. Closure 401 has two access wells 404 and 405. Well 404 has a tip-up access element 406 that provides user access to a tube 402 that may be immersed in a beverage in the beverage container when the closure is engaged to the beverage container. Well 405 has a second tip-up access element 407 that affords a user access to a sealed enclosure 403 that resides within the beverage container when the closure is engaged to the beverage container. There is a charging port 408 for recharging a battery in the closure, shown in FIGS. 5A and 5B.

FIG. 5A is a section view taken through closure 401 along a lengthwise centerline of access well 405. Access well 405 has a bottom surface with a rounded nest within which a spherical portion of access element 407 resides. The nest has a seal 506, which may be an o-ring, between the surface of the nest and the surface of the access element. The access element is pivoted on the sides of the access well such that it may be rotated around a center of the spherical portion.

Closure 401 has a female threading 501 by which the closure may engage the beverage container and may seal on a rubber seal 502.

Access element 407 has a passage 507 which may be aligned with a passage 508 at a lower region of the nest by rotating the access element about its pivots in the sides of the access well. In this example a heating element 504 with a threaded opening is engaged in an opening in the body 401 with the threaded opening facing down. A vape cartridge 505 is engaged in the threaded opening of the heating element. A cylindrical cover 403 is engaged to male threads extending down from body 401 and seals against a seal 503 isolating the vape cartridge from the rest of the inside of the beverage container with the closure engaged to the beverage container.

A rechargeable battery 506 of a voltage compatible with heating element 504 is enclosed in body 401 and is connected internally to heating element 504. The battery may have a voltage capacity between 2 and 5 volts, and a voltage of 4.7 V DC is common for vape apparatus.

FIG. 5B shows the cross section of FIG. 5A with access element 407 rotated such that passage 507 aligns with passage 508. In this circumstance a user may draw on the open end of the access element and a pressure sensor in the heating element triggers power to the heating element to vaporize material drawn from vape cartridge 505. A passage 509 allows air from outside into enclosure 403 such that the user may draw from the vape cartridge.

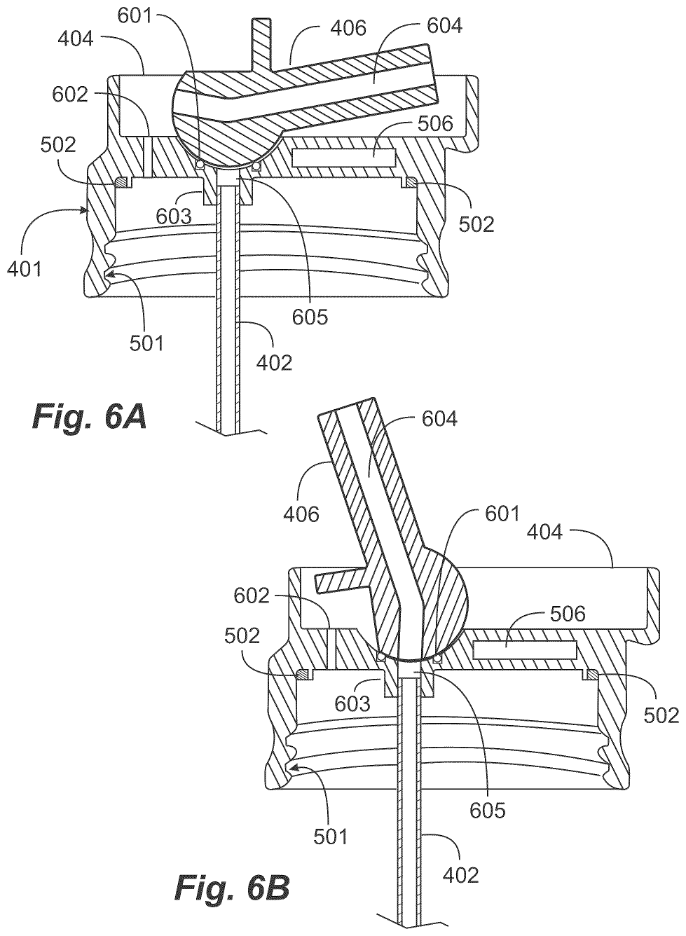

FIG. 6A is a section view taken through closure 401 along a lengthwise centerline of access well 404. Access well 404 has a bottom surface with a rounded nest within which a spherical portion of access element 406 resides. The nest has a seal 601, which may be an o-ring, between the surface of the nest and the surface of the access element. The access element is pivoted on the sides of the access well such that it may be rotated around a center of the spherical portion. A passage 602 allows outside air into the beverage container though a floor of access well 404. A passage 605 proceeds from a lower part of the nest to a tube 402 engaged in an extension 603 of the body of the closure.

With closure 401 engaged to a beverage container by threads 501 and sealed on seal 502, a user may rotate access element 406 about the pivots on the sides of the access well and align passage 604 with passage 605 as shown in FIG. 6B. A user may draw a beverage from the beverage container through passage 604 in this circumstance and rotate access element back to a closed position when finished.

It may be seen from FIGS. 5A, 5B, 6A and 6B that closure 401 allows a user a choice to draw vapor through a heating element from material in a vape cartridge, or to imbibe a beverage from the beverage container. When vape cartridge 505 is depleted the user may disengage the closure from the beverage container, remove sealed enclosure 403, remove the depleted cartridge, and install a new cartridge. The sealed cover may then be re-installed and the closure re-engaged to the beverage container. When the installed battery 506 is depleted at it may be recharged through port 408.

The skilled person will understand that the descriptions are exemplary and not limiting to scope of the invention.

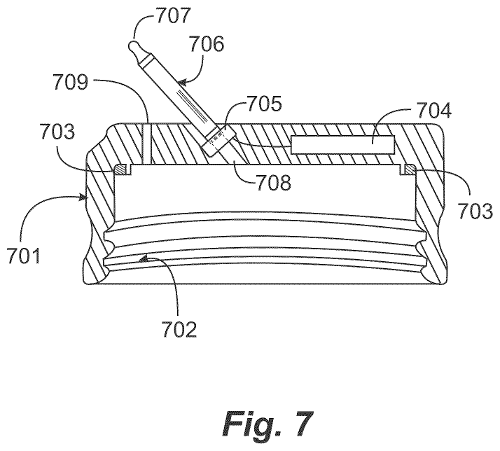

In another aspect of the invention a container closure is provided adapted to enable a user to engage a vape cartridge from outside the closure, with the closure engaged to a beverage container. FIG. 7 is a section view through a portion of a closure 701 having threads 702 for engaging the closure to a beverage container. When engaged the closure seals to the beverage container on seal 703. A heating element 705 having a pressure sensor is engaged in a passage 708 through a top of the closure. The heating element is connected internally to a battery 704 enclosed in the body of the closure.

In this example a vape cartridge 706 having a mouthpiece 707 on one end and a threaded interface on the other, compatible with threads in the heating element, is engaged to the heating element. A separate vent passage 709 enables the user to draw through the vape cartridge. The user may carry vape cartridges separately and engage one to the heating element as desired, and may remove a spent cartridge and replace same with a full cartridge. In one embodiment of the invention a heating element 705 may be provided as shown in FIG. 7 in one portion of a closure 701, and a pivoting access element may be provided to draw beverage through a tube at another portion of the closure, as shown in FIGS. 6A and 6B.

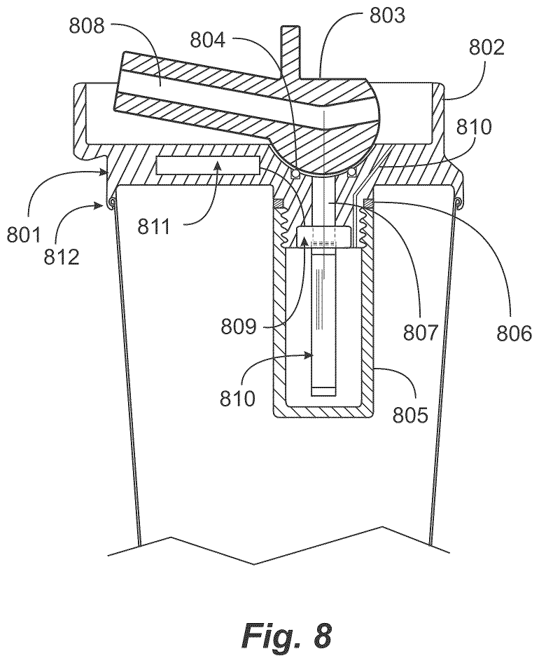

In yet another aspect of the invention a closure is provided that is adapted to snap onto a rim of a paper cup or other beverage container having a similar rim. FIG. 8 illustrates a closure 801 having a well 802 with a pivoting access element 803 having a passage 808. The access element has a spherical portion sealed to the closure by a seal element 804. In internal separate sealed enclosure 805 I sealed by a seal element 806 under the closure. A passage 807 leads through the closure from above to a heating element 809 which engages a vape cartridge 810 within the sealed enclosure. A rechargeable battery 811 is encased in the body of the closure and connected to the heating element. The is a vent passage 810 through the body into the separate enclosure. Body 801 has a flexible lip 812 that expands over a rim of a paper cup or other beverage container having a similar rim. Body 801 may also have a second access element and well as seen in FIGS. 6A and 6B for drawing a beverage from the beverage container.

The skilled person will understand that the embodiments illustrated and described in this application are exemplary only and are not limiting to the scope of the invention. The scope is limited only by the claims.

1. A closure for a beverage container, comprising:
a body having an attachment interface adapted to engage to a top of the beverage container;
a separate enclosure sealed to an underside of the body of the closure;
a first access element providing a first passage from above the body of the closure through and into the separate enclosure;
a heating element having a through passage engaged in the first passage with a threaded interface opening into the separate enclosure, the heating element having a pressure sensor;
a rechargeable battery encased in the body of the closure, the battery connected to the heating element;
a vape cartridge with a threaded end engaged in the threaded interface of the heating element, the vape cartridge suspended within the separate enclosure; and
a second access element providing a second passage from above the body of the closure to a tubing extending downward from an underside of the body of the closure;
wherein a user is enabled to draw liquid from the vape cartridge by the first access element, the pressure sensor triggering the heating element to vaporize the liquid, which the user draws through the first passage.

2. The closure of claim 1 wherein the beverage container holds a beverage outside the separate, sealed enclosure, the tubing from the second passage extends into the beverage, and the user is enabled to draw beverage by the second access element through the tubing and the second passage.

3. The closure of claim 1 wherein the first access element is a pivoted element in a first access well, manually operable to rotate into the first access well closing the first passage, and to rotate to a raised position opening the first passage to the heating element and enabling the user to draw vapor.

4. The closure of claim 1 wherein the second access element is a pivoted element in a second access well, manually operable to rotate into the second access well closing the second passage, and to rotate to a raised position opening the second passage to the tubing and enabling the user to draw beverage through the tubing and the second passage.

5. The closure of claim 1 wherein the attachment interface adapted to engage to a top of the beverage container is a female thread adapted to engage a male threaded beverage container.

6. The closure of claim 1 wherein the attachment interface adapted to engage to a top of the beverage container is a male thread adapted to engage a female threaded beverage container.

7. The closure of claim 1 wherein the attachment interface adapted to engage to a top of the beverage container is a flexible lip adapted to snap onto a rim of a paper cup or a beverage container having a rim similar to that of a paper cup.

8. A closure for a beverage container, comprising:
a body having an attachment interface adapted to engage to a top of the beverage container;
a first passage from above the body of the closure through and into a volume within the beverage container;
a heating element having a through passage engaged in the first passage with a threaded interface opening upward from a top of the closure, the heating element having a pressure sensor;
a rechargeable battery encased in the body of the closure, the battery connected to the heating element;
a vape cartridge with a threaded end engaged in the threaded interface of the heating element, the vape cartridge having a a mouthpiece on an end opposite the threaded end; and
an access element providing a second passage from above the body of the closure to a tubing extending downward from an underside of the body of the closure;
wherein a user is enabled to draw liquid from the vape cartridge by the first access element, the pressure sensor triggering the heating element to vaporize the liquid, which the user draws through the first passage, and wherein the user is enabled to draw beverage from the beverage container through the second access element and the tubing.

9. The closure of claim 8 wherein the access element is a pivoted element in an access well, manually operable to rotate into the access well closing the second passage, and to rotate to a raised position opening the second passage to the tubing enabling the user to draw beverage.

10. The closure of claim 8 wherein the attachment interface adapted to engage to a top of the beverage container is a female thread adapted to engage a male threaded beverage container.

11. The closure of claim 8 wherein the attachment interface adapted to engage to a top of the beverage container is a male thread adapted to engage a female threaded beverage container.

12. The closure of claim 1 wherein the attachment interface adapted to engage to a top of the beverage container is a flexible lip adapted to snap onto a rim of a paper cup or a beverage container having a rim similar to that of a paper cup.
